(19) United States
(12) Patent Application Publication
(10) Pub. No.: US 2024/0070559 A1
(43) Pub. Date: Feb. 29, 2024

(54) System for Usable Space Selection

(71) Applicant: Ice Exchange, Inc., Cos Cob, CT (US)

(72) Inventor: Christopher Michael Myhro, Cos Cob, CT (US)

(73) Assignee: Ice Exchange, Inc., Cos Cob, CT (US)

(21) Appl. No.: 18/237,946

(22) Filed: Aug. 25, 2023

Related U.S. Application Data
(60) Provisional application No. 63/401,207, filed on Aug. 26, 2022.

(51) Int. Cl. G06Q 10/02; G06Q 30/0283; G06Q 30/0645

(52) U.S. Cl. CPC G06Q 10/02; G06Q 30/0284; G06Q 30/0645

(57) ABSTRACT

An example system for usable space selection is provided. The system includes a database electronically storing data associated with one or more usable spaces available for purchase or rent from a first user. The data includes a geographic location of the one or more usable spaces, and a time period of availability of the one or more usable spaces. The system allows for selection of a desired usable space for a specific time period for use and a size associated with the desired usable space. The system allows for partitioning of the specified time period of the selected desired usable space into partitioned time periods, or the size of the selected desired usable space into partitioned sizes. The system allows the user to list for purchase or rent the partitioned time periods or the partitioned sizes of the usable space.

### CROSS-REFERENCE TO RELATED APPLICATIONS

This application claims the benefit of a co-pending U.S. Provisional Patent Application No. 63/401,207, which was filed on Aug. 26, 2022. The entire content of the foregoing provisional application is incorporated herein by reference.

### BACKGROUND

Usable spaces, such as ice rinks, soccer fields, football fields, basketball courts, tennis courts, outdoor fields/spaces, indoor spaces, or the like, may be available for purchase or rent by individuals/organizations for conducting certain events in the usable spaces. In general, an owner of the usable space makes the entire usable space available for purchase or rent by another individual/organization for a specific period of time.

As an example, an ice rink owner can make the ice rink available for rent by a hockey team such that the ice rink can be used on a weekly basis for team practice and games. As a further example, the ice rink owner can make the same ice rink available for birthday parties when the ice rink is not being used by the hockey team. In both instances, the entire ice rink is rented out and the ice rink remains unused during the time periods when the owner is unable to sell or rent the ice rink space. However, it remains necessary for the ice rink owner to pay for utilities and maintain the ice rink in a usable condition for the times when the ice rink is used by others. This can result in an expensive and inefficient venture for the owner.

### SUMMARY

Embodiments of the present disclosure provide an exemplary system for usable space selection. The system allows for the owner to sell or rent the usable space to other individuals/organizations, and the individuals/organizations are able to partition the space and/or time of use of the space to further sell or rent the partitioned space/time of use to others. The system provides flexibility in how the usable space is rented and used, and increases the opportunities for filling the available times for use of the space by individuals/organizations. The potential profit opportunities for the owner are thereby increased, and the time in which the space is unused is reduced. Inefficiencies of usable space ownership and lost value encountered through traditional methods are therefore reduced.

In accordance with embodiments of the present disclosure, an exemplary system for usable space selection is provided. The system includes a database electronically storing data associated with one or more usable spaces available for purchase or rent from a first user. The data includes a geographic location of the one or more usable spaces, and a time period of availability of the one or more usable spaces. The system includes a processing device in communication the database. The processing device is configured to receive as input a query from a second user regarding a desired geographic location of the one or more usable spaces available for purchase or rent. The processing device is configured to receive a selection from the second user of a desired usable space of the one or more usable spaces, the selection including a specific time period for use of the desired usable space, and a size associated with the desired usable space. The processing device is configured to receive a partitioning input from the second user to partition at least one of the specified time period of the selected desired usable space into partitioned time periods, or the size of the selected desired usable space into partitioned sizes. The processing device is configured to receive a command to add the selected desired usable space to the database as available for purchase or rent from the second user for at least one of the partitioned time periods or the partitioned sizes.

In some embodiments, the one or more usable spaces can include an ice rink, a soccer field, a football field, a tennis court, or a basketball court. In some embodiments, the one or more usable spaces can include an ice rink, the size associated with the desired usable space is a full ice rink, and the partitioned sizes includes halves, thirds, or quarters of the full ice rink. In some embodiments, the size associated with the desired usable space is a full space, and the partitioned sizes includes halves, thirds, or quarters of the full space.

In some embodiments, the specific time period selected for use of the desired usable space can be about 60 minutes, and the partitioned time periods can be about 30 minute increments or about 15 minute increments. Each of the partitioned sizes of the selected desired usable space can be made available for purchase or rent from the second user for the selected specific time period using the system. Each of the partitioned time periods is smaller in time than the specific time period for use of the desired usable space selected by the second user. Each of the partitioned sizes is smaller in size than the size associated with the desired usable space selected by the second user.

In some embodiments, the processing device can be configured to automatically schedule a space preparation event for the selected desired usable space immediately prior to the specific time period for use of the desired usable space. In some embodiments, the space preparation event can include at least one modification of the desired usable space in preparation for an activity to be conducted at the desired usable space for the specific time period. In some embodiments, the at least one modification can include positioning of goals on an ice rink or a field, positioning of cones on the ice rink or the field, or resurfacing ice of the ice rink. In some embodiments, the processing device can be configured to automatically schedule a space preparation event for each of the partitioned time periods and each of the partitioned sizes available for purchase or rent from the second user. In some embodiments, the space preparation events can be automatically scheduled between each of the partitioned time periods. In some embodiments, the processing device can be configured to automatically adjust a length of each of the partitioned time periods to accommodate the scheduled space preparation event.

In accordance with embodiments of the present disclosure, an exemplary method for usable space selection is provided. The method includes electronically storing in a database data associated with one or more usable spaces available or purchase or rent from a first user. The data can include a geographic location of the one or more usable spaces, and a time period of availability of the one or more usable spaces. The method includes receiving as input, via a processing device, a query from a second user regarding a desired geographic location of the one or more usable spaces available for purchase or rent. The method includes receiving a selection, via the processing device, from the second user of a desired usable space of the one or more usable spaces. The selection includes a specific time period for use of the desired usable space, and a size associated with the desired usable space. The method includes receiving a partitioning input, via the processing device, from the second user to partition at least one of the specific time period of the selected desired usable space into partitioned time periods, or the size of the selected desired usable space into partitioned sizes. The method includes receiving a command, via the processing device, to add the selected desired usable space to the database as available for purchase or rent from the second user for at least one of the partitioned time period or the partitioned sizes.

Each of the partitioned time periods is smaller in time than the specific time period for use of the desired usable space selected by the second user. Each of the partitioned sizes is smaller in size than the size associated with the desired usable space selected by the second user. In some embodiments, the method can include automatically scheduling a space preparation event for the selected desired usable space immediately prior to the specific time period for use of the desired usable space. In some embodiments, the space preparation event can include at least one modification of the desired usable space in preparation for an activity to be conducted at the desired usable space for the specific time period. In some embodiments, the at least one modification can include positioning of goals on an ice rink or a field, positioning of cones on the ice rink or the field, or resurfacing ice of the ice rink. In some embodiments, the method can include automatically scheduling a space preparation event for each of the partitioned time periods and each of the partitioned sizes available for purchase or rent from the second user.

In accordance with embodiments of the present disclosure, an exemplary non-transitory computer-readable medium storing instructions for usable space selection that are executable by a processing device is provided. Execution of the instructions by the processing device causes the processing device to electronically store in a database data associated with one or more usable spaces available or purchase or rent from a first user. The data includes a geographic location of the one or more usable spaces, and a time period of availability of the one or more usable spaces. Execution of the instructions by the processing device causes the processing device to receive as input, via a processing device, a query from a second user regarding a desired geographic location of the one or more usable spaces available for purchase or rent. Execution of the instructions by the processing device causes the processing device to receive a selection, via the processing device, from the second user of a desired usable space of the one or more usable spaces. The selection includes a specific time period for use of the desired usable space, and a size associated with the desired usable space. Execution of the instructions by the processing device causes the processing device to receive a partitioning input, via the processing device, from the second user to partition at least one of the specific time period of the selected desired usable space into partitioned time periods, or the size of the selected desired usable space into partitioned sizes. Execution of the instructions by the processing device causes the processing device to receive a command, via the processing device, to add the selected desired usable space to the database as available for purchase or rent from the second user for at least one of the partitioned time period or the partitioned sizes.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the usable space selection system, reference is made to the accompanying figures, wherein:

FIG. 1 is diagrammatic view of a usable space capable of being sold, partitioned, and resold using the exemplary usable space selection system in accordance with embodiments of the present disclosure;

FIG. 2 is a block diagram of an exemplary usable space selection system in accordance with the present disclosure;

FIG. 3 is a block diagram of an exemplary computing device for implementing the exemplary usable space selection system in accordance with the present disclosure;

FIG. 4 is a block diagram of an exemplary usable space selection system environment in accordance with the present disclosure;

FIG. 5 is a flowchart illustrating a process for operation of an exemplary usable space selection system in accordance with the present disclosure;

FIG. 6 is a flowchart illustrating a process for operation of an exemplary usable space selection system in accordance with the present disclosure;

FIG. 7 is a diagrammatic view of a user interface of an exemplary usable space selection system in accordance with the present disclosure;

FIG. 8 is a diagrammatic view of a user interface of an exemplary usable space selection system in accordance with the present disclosure;

FIG. 9 is a diagrammatic view of a user interface of an exemplary usable space selection system in accordance with the present disclosure;

FIG. 10 is a diagrammatic view of a user interface of an exemplary usable space selection system in accordance with the present disclosure;

FIG. 11 is a flowchart of a process associated with use of an exemplary usable space selection system in accordance with the present disclosure;

FIG. 12 is a flowchart of a process associated with use of an exemplary usable space selection system in accordance with the present disclosure; and

FIG. 13 is a diagrammatic view of a user interface of an exemplary usable space selection system in accordance with the present disclosure.

### DETAILED DESCRIPTION

The exemplary usable space selection system described herein provides flexibility in purchasing/renting a usable space by the “original” owner to other individuals and/or organizations, by permitting the original purchaser or renter to subsequently partition the usable space for further purchase or rent. The system creates an environment in which the unused time of the usable space can be reduced, and can provide for various partitions and/or uses of the space.

The system allows a buyer to resell the contract for a usable space to another organization/individual who then could resell the contract to another organization/individual or create a new program and resell it as an open spot(s). The system can be provided as a cloud-based software solution including a marketplace that allows the facilities (e.g., ice rinks), hockey organizations (e.g., teams), and coaches and individual customers to buy, sell, and trade ice time. Although discussed herein with respect to an ice rink, it should be understood that the system can be used with any other usable space in a similar manner, e.g., commodity ice, grass space, hardwood courts, or the like. The system enables users to view available/rentable ice/court/field time periods (referred to herein as “slots” or “time slots”), exchange slots, sell slots, bargain for slots, and/or allocate slots. In some embodiments, the system can provide an insurance option when performing the transaction, e.g., at checkout, by either requesting that the user submit proof of a certificate of insurance (COI) or an option to purchase/add insurance to the transaction. In some embodiments, rather than sport-based spaces, the system can be used for selling and/or partitioning of office or ancillary spaces.

A facility operator can use the system to electronically manage the scheduling of slots, sell slots, collect slot payments, allocate slots, and/or optimize the use and revenue from their open ice, field, or court time. Users can use the system to search for their desired type of slot by a number of variables, including geographic area, cost, time of day, description of organizational program available, by age-appropriate programs, simple rink programs such as stick and puck, public session, freestyle skating, and open hockey. Users can use the system to organize their schedules, publish schedules to the public, publish schedules to their organization, and/or publish schedules to certain individuals in their organization. The system can be used to book open ice time, create new schedule(s), and invite friends to participate in the program. The owner of the usable space can use the system to monitor (via a graphical user interface) what happens with the original rink schedule (e.g., the “parent schedule” or the “original schedule”) and the changes to the parent schedule amongst buyers (e.g., the “child schedule” or the “sub-schedule”).

The system can be used with any business which has sports related slots, such as ice skating rinks, tennis courts, soccer fields or pitch, field hockey, field pitch, speed skating rink, Olympic rink, lacrosse field, lacrosse pitch, squash court, pickle ball court, badminton court, basketball court, Handball court, jai alai court, lawn tennis, Paddleball, paddle tennis, handball, netball, croquet, curling, or cricket. The system can be used for any sport played on a pitch, field, court, rink, stadium, or a field of play consisting of artificial turf, sod, sand, clay, gravel concrete, or other materials.

The system provides the ability to resell a contract for a usable space or buy and then create a new program to be sold by the number of seats/spots available. For example, a second user can buy the rental ice time from a first user; the second user can put the ice up for resell; and a third user can buy the ice and create a program for 20 players to sign up for a clinic on power skating. The system provides owners of slots the ability to sell/exchange pre-bought/contracted but un-needed slots. The system allow users the ability to search and acquire slots from facilities or other users across a broad spectrum of times, usage and geographies.

The system allows for elimination of the inefficiencies inherent in a single user attempting to find slots across a spectrum of geographically dispersed facilities. In some embodiments, the system can include a colored dot system for available, resellable, booked or my slot designations. In some embodiments, the graphical user interface can have a live stream to the rink when viewing the rinks on the website to be sold. In some embodiments, the graphical user interface can include a feedback video from the session/time period sold on the system 100 back to the user, with the video stream providing visibility of the usable space purchased/rented and/or the activity occurring at the purchased/rented time period. After partitioning, the system allows user to sell the ice in halves, quarters or thirds. Once the space is partitioned, the user can upload these partitions to the system such that others can purchase/rent the partitioned space from the user.

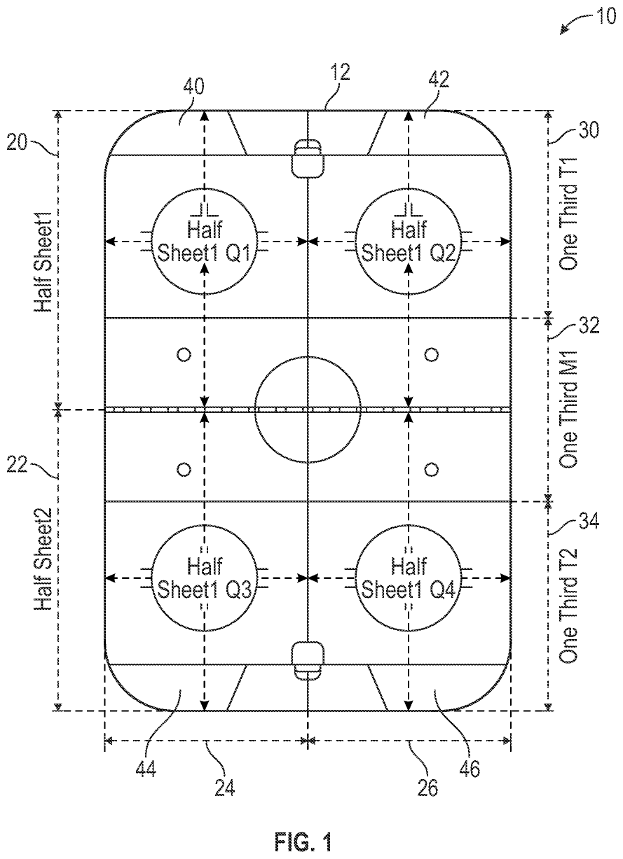

FIG. 1 is a diagrammatic view of a usable space 10 (referred to herein as “space 10”) capable of being sold, partitioned, and resold using the exemplary system. Although illustrated as an ice rink, it should be understood that other types of spaces could be similarly partitioned. The space 10 generally defines an original, non-partitioned size or space 12 (e.g., a full space), which can be partitioned using the system into smaller sizes. For example, the original space 12 can be partitioned into halves (e.g., horizontally split halves 20, 22 or vertically split halves 24, 26), thirds 30, 32, 34, quarters 40, 42, 44, 46, or the like.

In some embodiments, the owner of the space 10 can provide for purchase or rent the entire space 12 for use by one or more other individuals/organizations. A user can agree to purchase or rent the entire space 12 for a predetermined period of time, and can use the system to partition the space 12 into smaller partitioned spaces or sub-spaces (e.g., halves, thirds, quarters). In some embodiments, the user can partition the space 12 into equal sub-spaces, such as those illustrated in FIG. 1. In some embodiments, the user can partition the space 12 into unequal sub-spaces (e.g., a half 20, and quarters 44, 46). In some embodiments, the system can execute a mite program to divide the space 12 into the desired number of partitions or sub-spaces, and other users can purchase/rent the partitioned spaces. The originally obtained space 12 can therefore be partitioned in any sub-spaces desired by the user, and one or more of the sub-spaces can be further made available for purchase or rent by others. In some embodiments, the user can decide to maintain use of one of the sub-spaces, while making the other sub-spaces available for purchase or rent by other users.

In some embodiments, the owner of the space 10 can partition the entire space 12 before initially making the space 12 available to others for purchase or rent. For example, the owner can partition the space 12 into the halves 20, 22, and each of the halves 20, 22 could be rented by two different individuals/organizations for use during the same or different periods of time. Each of the individuals/organizations renting the halves 20, 22 could either use the respective halves 20, 22 for activities, or could partition their respective halves 20, 22 and make the partitioned sub-spaces available for purchase or rent by others.

In some embodiments, the system can be used to partition use of the space 10 based on periods of time. For example, the owner of the space 10 can rent out the entire space 12 to a user for a period of four hours. The user can, in turn, partition the entire space 12 into, e.g., four 1 hour intervals, two 2 hour intervals, one 2 hour interval and two 1 hour intervals, or the like. The user can subsequently make the space 12 available for others to use or rent during the partitioned time periods.

In some embodiments, the system can be used to partition the space in both a physical space manner and a period of time manner. For example, the entire space 12 can be rented by a user for four hours. The user can partition the space 12 into the halves 20, 22. The first half 20 can be made available for rent for four 1 hour intervals, and the second half 22 can be made available for rent for a single 4 hour interval. The system therefore provides flexibility and variability in the manner in which the space 10 can be partitioned for subsequent purchase or rent by others.

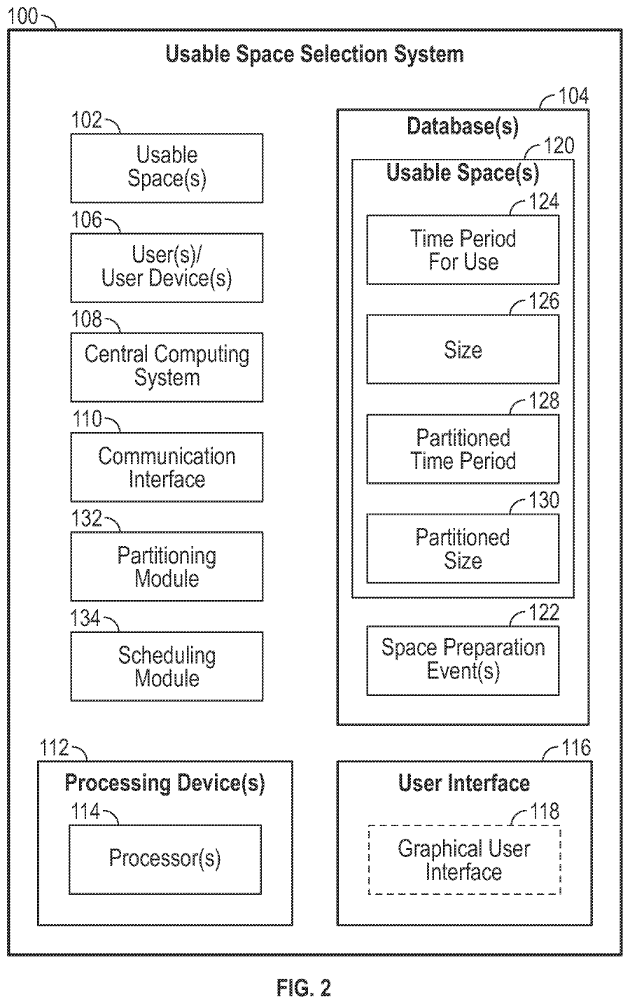

With reference to FIG. 2, a block diagram of an exemplary usable space selection system 100 (hereinafter “system 100”) is provided. The system 100 generally includes one or more usable spaces 102, one or more databases 104, and one or more users and/or user devices 106. A central computing system 108 can be in communication with each of the usable spaces 102, the databases 104, and the user devices 106 through a communication interface 110. The communication interface 110 is configured to provide for a communication network between components of the system 100, thereby allowing data to be electronically transmitted and/or received by the components of the system 100. The system 100 can include at least one processing device 112 with a processor 114 for receiving and processing the data stored in the system 100. The system 100 includes at least one user interface 116. In some embodiments, the user interface 116 can include a display in the form of a graphical user interface (GUI) 118. The GUI 132 can be a display incorporated into the user devices 106 to allow for users or owners of the usable spaces 102 to communicate with each other via the communication interface 110.

The database 104 can receive and electronically store data associated with implementation of the system 100. Such data can be usable space data 120, space preparation event data 122, combinations thereof, or the like. The usable space data 120 can include information relating to, e.g., time periods for use 124, sizes 126, partitioned time periods 128, partitioned sizes 130, combinations thereof, or the like. As an example, for each of the usable spaces 102, the initial data stored in the system 100 can include general information on the usable space 120 (such as the address and owner information), and more detailed information (such as the different sizes 126 of the space available for purchase/rent and the time periods for use 124 of the space available).

Once the owner sells/rents the usable space 102 for a particular time period for use 124 and a specific size 126 of the space for such use, the other user (e.g., buyer/renter) can partition the purchased/rented usable space 102. The processing device 112 can execute a partitioning module 132 to partition the purchased/rented space 102 into smaller partitioned time periods 128 and/or smaller partitioned sizes 130. As an example, the original time period for use 124 can be 4 hours and the size 126 can be a full ice rink when purchased/rented by a user from the owner of the ice rink. The user can subsequently partition the purchased/rented space using the partitioning module 132 of the system 100. The user can partition the time period for use into smaller partitioned time periods 128 (e.g., two 2 hour time slots, one 1 hour slot, and one 3 hour time slot, or the like), can partition the size into smaller partitioned sizes 130 (e.g., quarters, halves, thirds, or the like), or both. The user can then list each of the partitioned sizes 130 with their respective available time periods for use 124 (or partitioned time periods 128 for use) for purchase/rent by other users.

As the usable spaces 102 are purchased/rented, and/or as the partitioned sizes 130 of the usable spaces 102 are purchased/rented, the processing device 112 can execute a scheduling module 134 to automatically create a schedule that accommodates one or more space preparation events 122 for use of the space. For example, resurfacing of the ice in an ice rink may be necessary between certain events, or goals may need to be positioned or repositioned based on the size of the usable space being used during each respective time period. In some embodiments, the space preparation event 122 can be customized based on customized partitioning of the usable space 102. For example, if a usable space 102 is rented by a first user for two hours, the first user can partition the usable space 102 into two time periods of, e.g., one hour each, or the like. For the first hour, the first user can rent the entire space for a clinic of 30 players, and the second hour the first user can rent as four separate quadrants or partitions to individual coaches for private lessons for their students. The partitioning by time period and physical space can be performed by the system 100, and the scheduling module 134 automatically creates space preparation events 122 based on the type of partitioning to ensure the usable space 102 is appropriately set up for use based on the specific customized needs of the user(s). The scheduling module 134 can therefore ensure that a seamless schedule is generated for use of the usable space without overlap and interference between users. Operation of the system 100 increases the opportunities for the usable space to be purchased/rented by other users, thereby increasing profits for the owner of the usable space and providing potentially more convenient accommodations for use of the space to users who may need the space (or smaller space) for shorter periods of time than traditionally allotted.

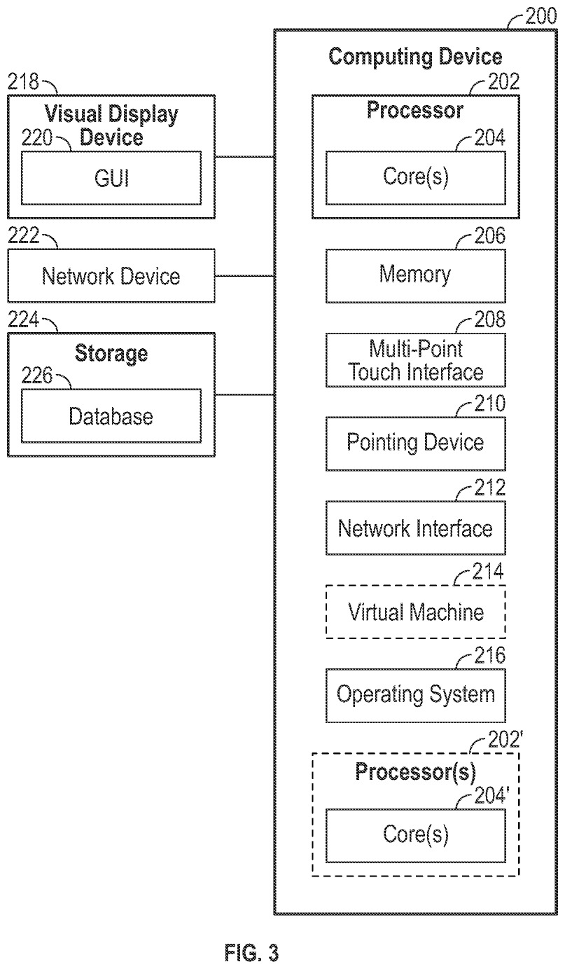

FIG. 3 is a block diagram of a computing device 200 in accordance with exemplary embodiments of the present disclosure. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in the computing device 200 may store computer-readable and computer-executable instructions or software for implementing exemplary embodiments of the present disclosure (e.g., instructions for operating the processing device, instructions for operating the communication interface, instructions for operating the user interface, instructions for operating the central computing system, combinations thereof, or the like). The computing device 200 also includes configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in the computing device 200 so that infrastructure and resources in the computing device 200 may be shared dynamically. A virtual machine 214 may be provided to handle a process running on multiple processors so that the process appears to be using only one computing resource rather than multiple computing resources. Multiple virtual machines may also be used with one processor. Memory 206 may include a computer system memory or random access memory, such as DRAM, SRAM, EDO RAM, and the like. Memory 206 may include other types of memory as well, or combinations thereof.

A user may interact with the computing device 200 through a visual display device 218 (e.g., a personal computer, a mobile smart device, or the like), such as a computer monitor, which may display at least one user interface 220 (e.g., a graphical user interface) that may be provided in accordance with exemplary embodiments. The computing device 200 may include other I/O devices for receiving input from a user, for example, a camera, a keyboard, microphone, or any suitable multi-point touch interface 208, a pointing device 210 (e.g., a mouse). The keyboard 208 and the pointing device 210 may be coupled to the visual display device 218. The computing device 200 may include other suitable conventional I/O peripherals.

The computing device 200 may also include at least one storage device 224, such as a hard-drive, CD-ROM, eMMC (MultiMediaCard), SD (secure digital) card, flash drive, non-volatile storage media, or other computer readable media, for storing data and computer-readable instructions and/or software that implement exemplary embodiments of the system described herein. Exemplary storage device 224 may also store at least one database 226 for storing any suitable information required to implement exemplary embodiments. For example, exemplary storage device 224 can store at least one database 226 for storing information, such as data relating to usable spaces, time periods for use, sizes, partitioned time periods, partitioned sizes, space preparation events, combinations thereof, or the like, and computer-readable instructions and/or software that implement exemplary embodiments described herein. The databases 226 may be updated by manually or automatically at any suitable time to add, delete, and/or update one or more items in the databases.

The computing device 200 can include a network interface 212 configured to interface via at least one network device 222 with one or more networks, for example, a Local Area Network (LAN), a Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 212 may include a built-in network adapter, a network interface card, a PCMCIA network card, Pa Cl/PCIe network adapter, an SD adapter, a Bluetooth adapter, a card bus network adapter, a wireless network adapter, a USB network adapter, a modem or any other device suitable for interfacing the computing device 200 to any type of network capable of communication and performing the operations described herein. Moreover, the computing device 200 may be any computer system, such as a workstation, desktop computer, server, laptop, handheld computer, tablet computer (e.g., the tablet computer), mobile computing or communication device (e.g., the smart phone communication device), an embedded computing platform, or other form of computing or telecommunications device that is capable of communication and that has sufficient processor power and memory capacity to perform the operations described herein.

The computing device 200 may run any operating system 216, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 216 may be run in native mode or emulated mode. In an exemplary embodiment, the operating system 216 may be run on one or more cloud machine instances.

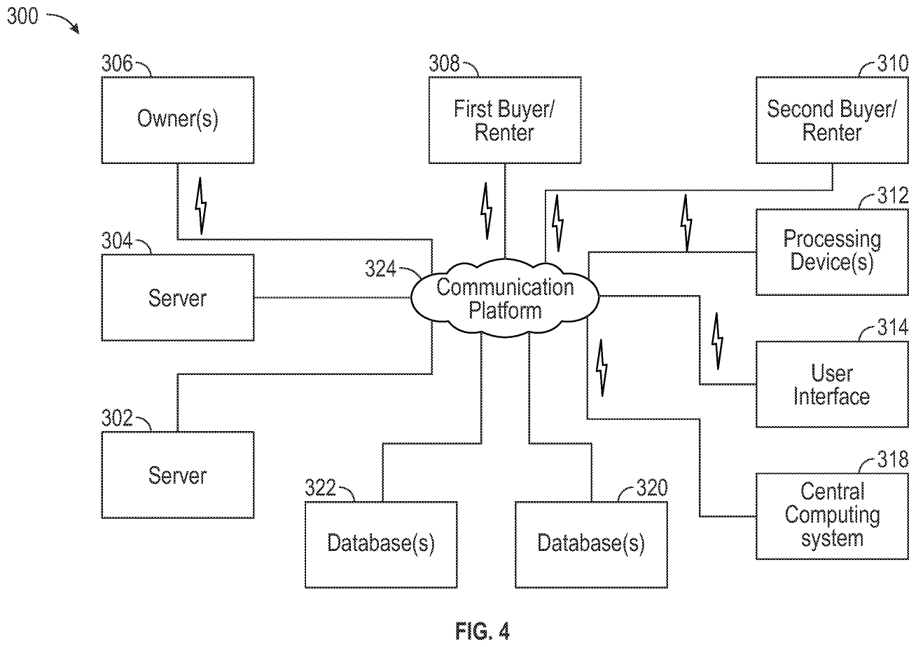

FIG. 4 is a block diagram of an exemplary usable space selection system environment 300 in accordance with exemplary embodiments of the present disclosure. The environment 300 can include servers 302, 304 configured to be in communication with at least one usable space owner 306, at least one first buyer/renter 308, at least one second buyer/renter 310, at least one processing device 312, at least one user interface 314, and a central computing system 318 via a communication platform 324, which can be any network over which information can be transmitted between devices communicatively coupled to the network. For example, the communication platform 324 can be the Internet, Intranet, virtual private network (VPN), wide area network (WAN), local area network (LAN), and the like. In some embodiments, the communication platform 324 can be part of a cloud environment.

The environment 300 can include repositories or databases 320, 322, which can be in communication with the servers 302, 304, as well as the at least one usable space owner 306, at least one first buyer/renter 308, at least one second buyer/renter 310, at least one processing device 312, at least one user interface 314, and central computing system 318, via the communications platform 324.

In exemplary embodiments, the servers 302, 304, at least one usable space owner 306, at least one first buyer/renter 308, at least one second buyer/renter 310, at least one processing device 312, at least one user interface 314, and central computing system 318 can be implemented as computing devices (e.g., computing device 200). Those skilled in the art will recognize that the databases 320, 322 can be incorporated into at least one of the servers 302, 304. In some embodiments, the databases 320, 322 can store data relating to probe images, enrollment data, authentication data, combinations thereof, or the like, and such data can be distributed over multiple databases 320, 322.

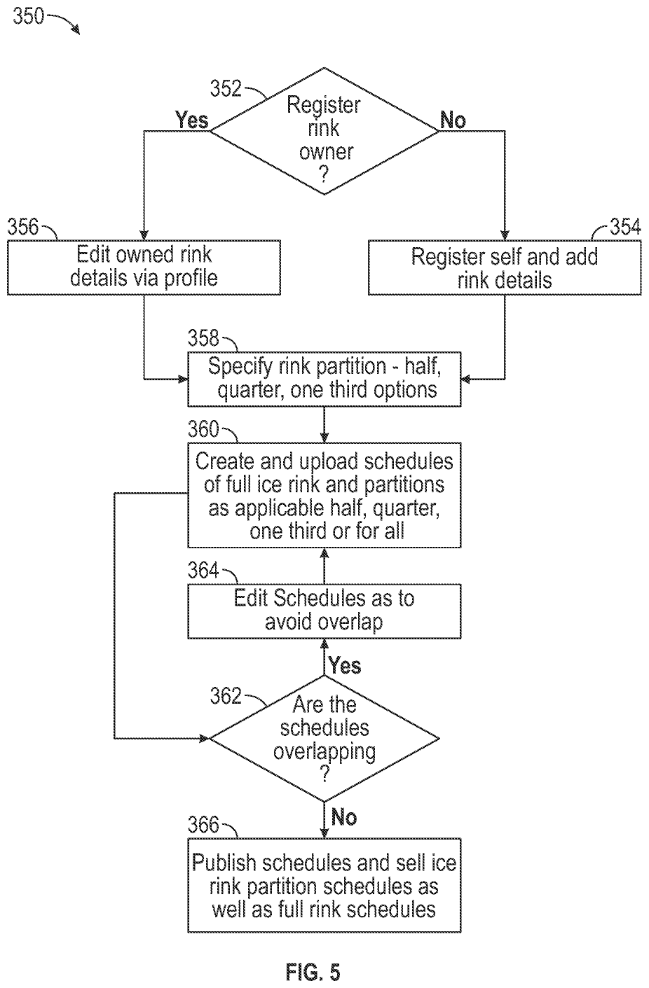

FIG. 5 is a flowchart illustrating a process 350 for operation of the system 100. In particular, the process 350 illustrates the steps for an owner of a usable space to make the space (or partitioned space) available for purchase/rent by others. At step 352, an owner of the usable space can register with the system 100 by inputting owner information. At step 354, the owner can input information on the owner himself/herself, as well as details about usable space (e.g., address, size, time of availability, or the like). If the owner had previously registered for the system 100, the process can proceed to step 356 where the owner can optionally edit the previously input information on the owner and usable space.

At step 358, the owner can specify details about the usable space, such as the different partitions available for purchase/rent. At step 360, the owner can create and upload a schedule for availability of either the full usable space or partitions of the space. At step 362, the system 100 can automatically analyze the schedule and determine if any schedules are overlapping. If yes, at step 364, the system 100 can request that the owner edit the schedule to avoid specific overlaps. At step 366, the schedule can be published by the system 100 and made available to the public, such that the public can purchase/rent either the full usable space or the partitioned space.

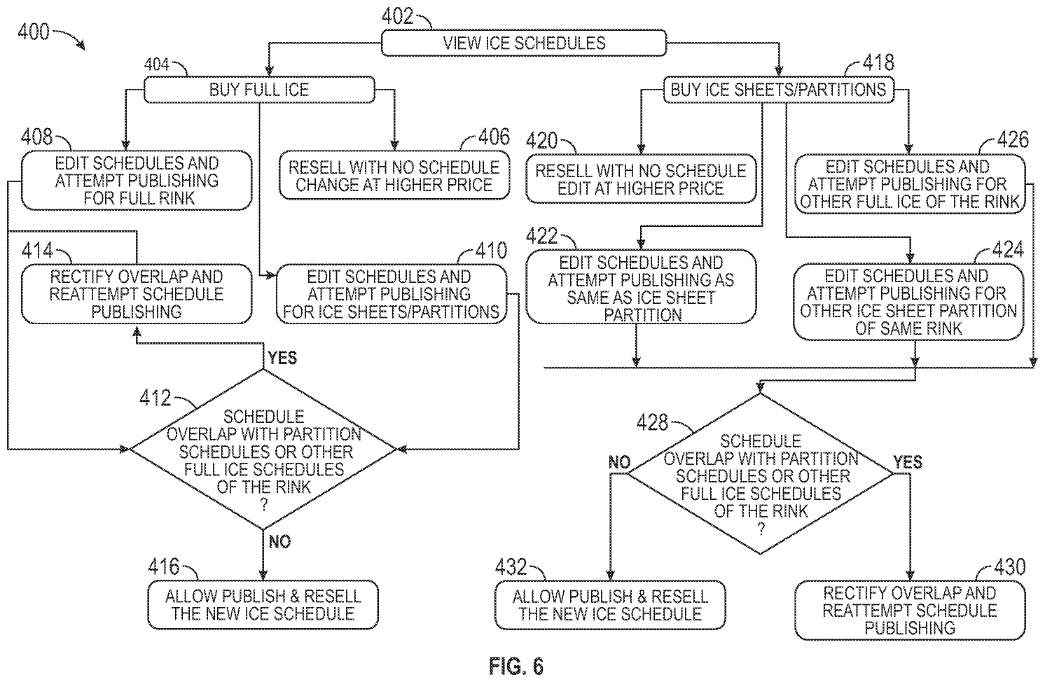

FIG. 6 is a flowchart illustrating a process 400 for operation of the system 100. In particular, the process 400 illustrates the steps of a user purchasing/renting a usable space (or partitioned space) made available by the owner via the system 100. At step 402, the user can view the schedules made available the owner for the usable space. At step 404, the user can select the desire to purchase/rent the full usable space. At step 406, the user can resell the usable space with no changes to the schedule (i.e., no partitioning of the physical space or the time for use of the space). At step 408, the user can decide to edit the schedule for the full usable space (i.e., partition the time periods for use of the space). At step 410, the user can decide to edit the schedule to partition the physical space for the same period of time. In some embodiments, the partitioned physical space can also be partitioned into different time periods than the original time period. At step 412, the system 100 can automatically detect any overlap in schedules and, if overlap is detected, at step 414, the system can request rescheduling by the user to correct any overlap. If no overlap is detected, at step 416, the system 100 allows publication and reselling of the usable space by the user.

Rather than buying the full usable space, at step 418, the user can elect to buy only partitions of the usable space. At step 420, the user can resell the purchased partitioned space with no schedule change and, optionally, at a higher price than originally paid for the usable space. At step 422, the user can elect to edit the schedule and resell the same partitioned space (e.g., changing only the time of use for the partition, but the physical partitioned space remaining the same). At step 424, the user can elect to edit the schedule by changing the physical partitioned space and/or the time period for use, and resell the further partitioned space. At step 426, the user can elect to edit the schedule and resell the full space. At step 428, the system 100 can analyze the updated schedule to determine if overlap in scheduling exists for the partitioned schedule and/or full space schedule. At step 430, if overlap is detected, the system 100 can request updates to the schedule. At step 432, if no overlap is detected, the system 100 can publish the partitioned space schedule for reselling.

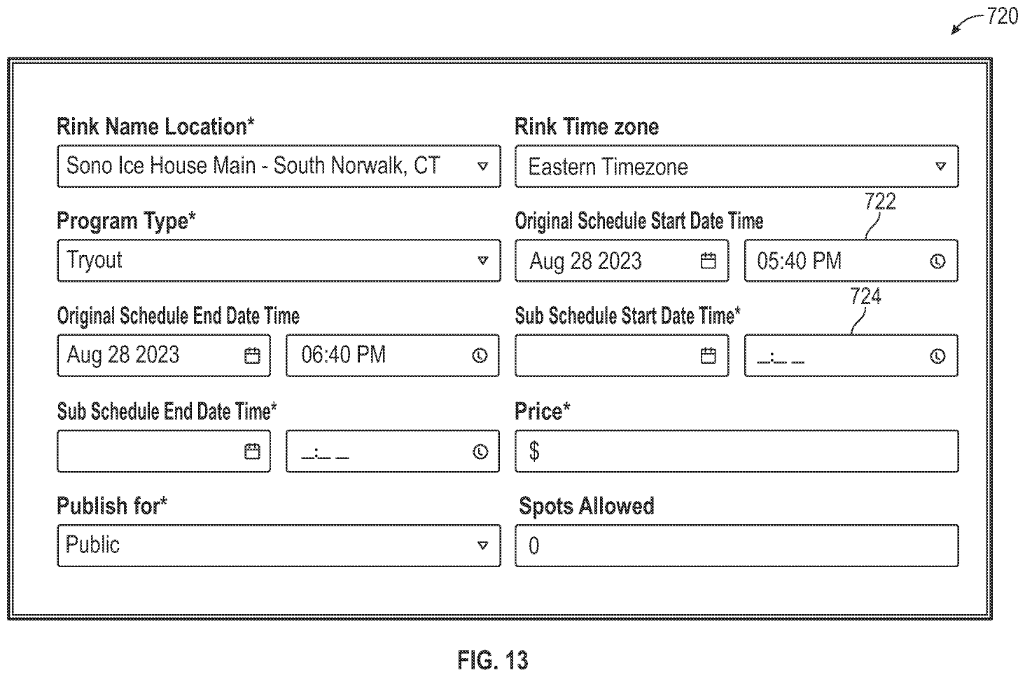

For spaces that have partitions registered with the system 100, the system 100 allows the creation of schedules for both the original size of the space (e.g., the parent size) as well as the associated partitions. The system 100 can validate that the original space/size schedule does not overlap with the associated partition schedules. If an overlap occurs, the schedule creation is prevented by alerting the user about the overlapping condition. Conflicts in scheduling are therefore prevented. For example FIG. 13 provides a user interface 720 in which a sub-schedule can be created for making available the full or partitioned usable space previously purchased by an individual. The user interface 720 can include the original start and end date/time 722 of the usable space, and the sub-schedule start date/time(s) 724. Once entered, the sub-schedule can be introduced to the system 100 pool for other users to see the available usable spaces and decide whether purchase/rent of a specific date/time of the usable space is desired.

The user interface for the system 100 can include a main screen that provides the following options, e.g., book usable space, sign up for a lesson at the usable space, register as a usable space owner, register as an organization, view existing schedules, organize a game/team, or the like. The user can select the appropriate sub-menu to begin use of the system 100 in the desired manner.

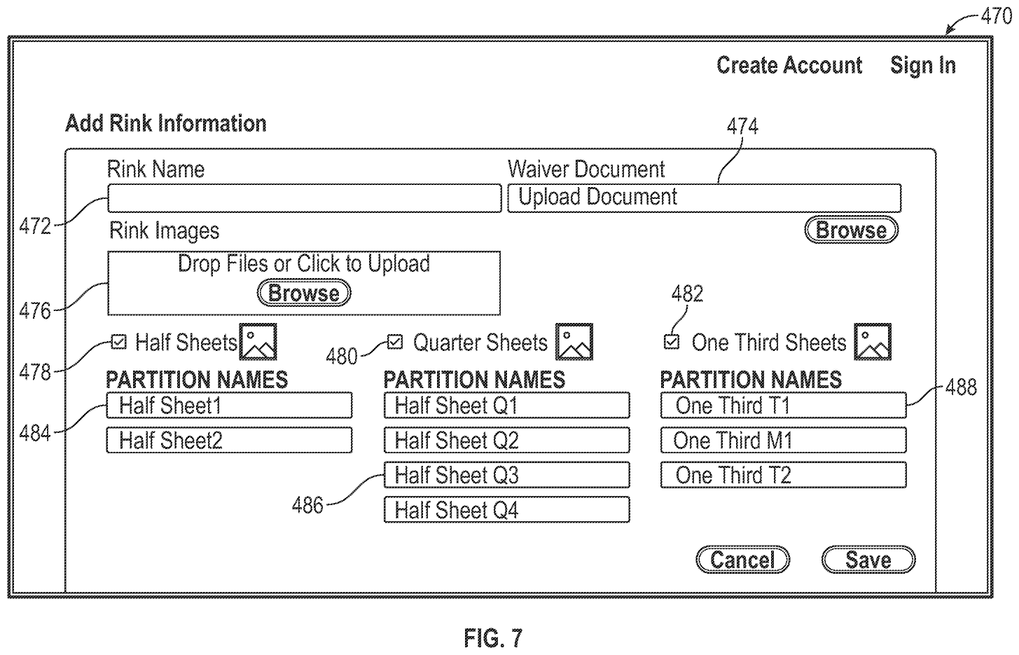

FIG. 7 is a diagrammatic view of a user interface 470 of the system 100. The interface 470 can provide means for setting up a facility or usable space for purchase/rent. The interface 470 can include several fields for input of data, e.g., name of usable space 472, upload of waiver document for safety of the owner 474, images of the usable space 476, and a selection 478, 480, 482 of the size of the usable space. The interface 470 can include additional fields 484, 486, 488 for specific names of the partitioned spaces. For example, if the user selects half partitioned spaces, each half can have a separate name. Similar input can be used for the names of quarters or thirds of the usable space.

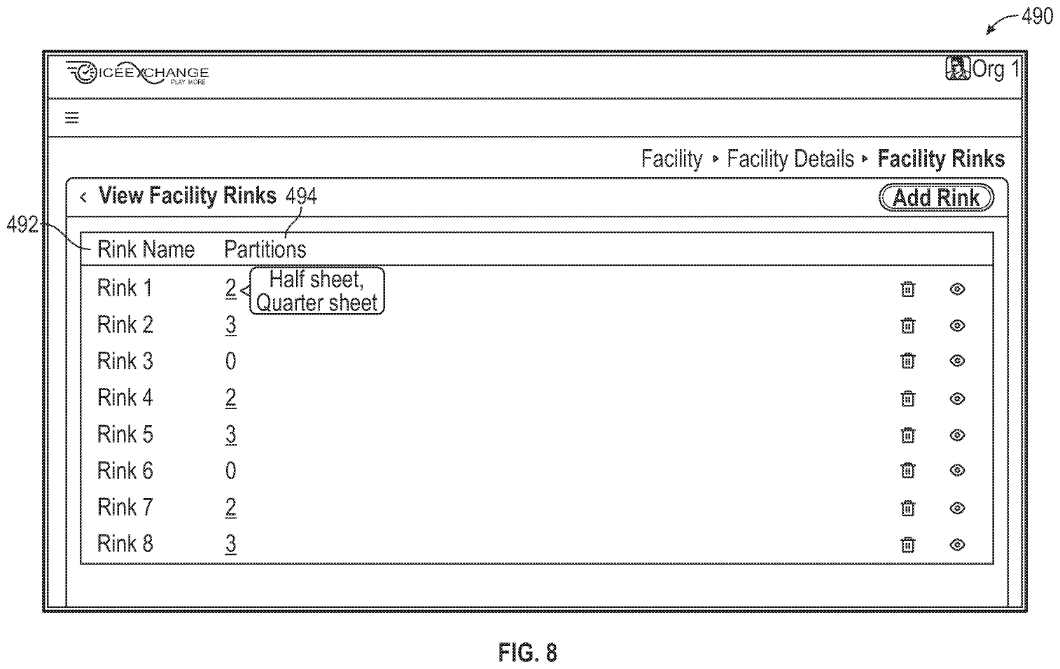

FIG. 8 is a diagrammatic view of a user interface 490 of the system 100. The interface 490 can provide a listing of different usable spaces by name 492. One column can designate whether the usable space is a full space or with partitions 494. The user can thereby review the available usable spaces based on specific desired size.

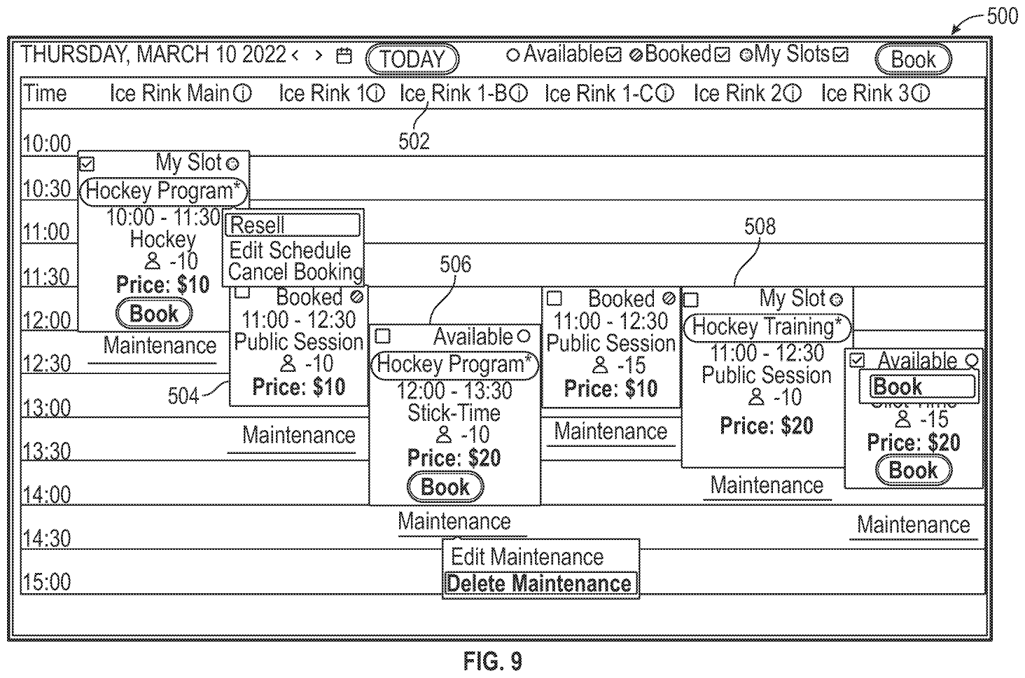

FIG. 9 is a diagrammatic view of a user interface 500 of the system 100. The interface 500 includes a top menu 502 with a selection of different usable spaces. Once a usable space is selected, the interface 500 includes a schedule with time periods for the usable space. Color designations can be used to indicate if the usable space is booked/unavailable during a specific time 504, if the usable space is available during a specific time 506, and if a specific slot has been booked by the user 508.

The user interface can provide a menu available to a user who has purchased/rented a usable space using the system 100. In the menu provided in interface, the user can either choose to resell the same usable space for the same period of time without changes, make changes to the space size and/or time period of use before reselling, or cancel the operation of reselling the space.

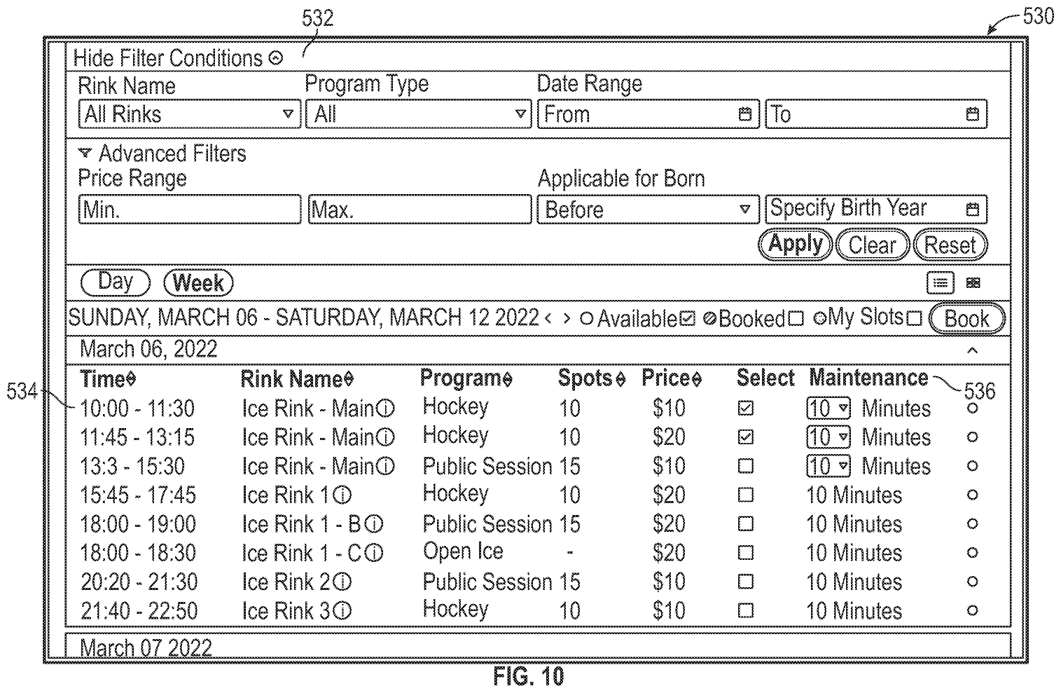

FIG. 10 is a diagrammatic view of a user interface 530 of the system 100. The interface 530 provides the option of booking the space for multiple periods of time, e.g., consolidating the usable space. The interface 530 includes a filter menu 532 that allows the user to limit the search by, e.g., usable space names, program types, date ranges, price ranges, before/to options, combinations thereof, or the like. The results listing 534 includes the different time periods during which the usable space is available for purchase/rent. The user can select multiple time periods to book consecutive time periods, for example, thereby extending the time period for use beyond the individual partitioned time periods.

The interface 530 of FIG. 10 can also provide the option for selecting specific time periods for maintenance of the usable space before and/or after the space is to be used. The interface 530 includes a filter menu 532 that allows the user to limit the search by, e.g., space name, program type, date range, price range, before/after options, birth year, combinations thereof, or the like. The results listing 534 includes different time periods during which the usable space is available for purchase/rent, the space name, the program type, the number of spaces available, prices, selection of space options, and maintenance time period selection 536. The selection 536 can include a drop down menu that allows the user to select the time allotted to maintenance before and/or after use of the space. In some embodiments, the user can manually select the time period needed for maintenance of the space. In some embodiments, the system 100 can automatically add or incorporate the maintenance time needed based on the selected time period of use.

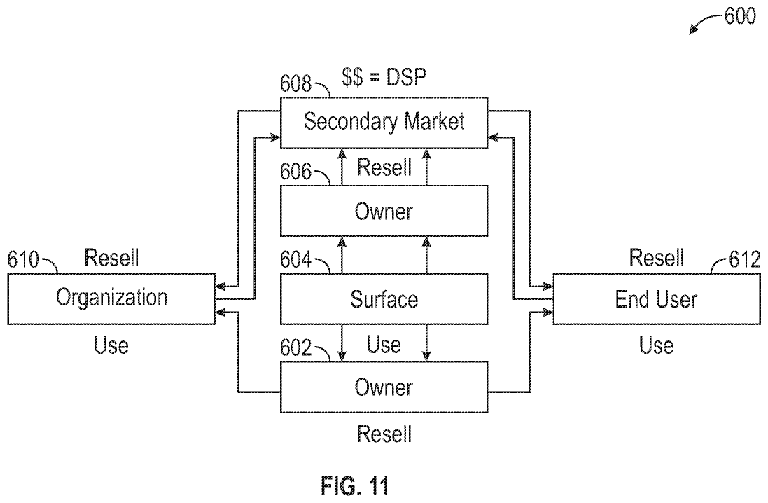

In some embodiments, the system 100 can be used in a dynamic surface pricing (DSP) manner. For example, FIG. 11 is a flowchart of a process 600 for implementing the system 100. The process 600 can be used for dynamic pricing of the usable space. At step 602, the original owner of the space (e.g., surface 604) can rent or sell the space to another owner (step 606). The second owner can make the space available on a secondary market via the system 100 (step 608). End users 612 and/or organizations 610 can electronically bid for the space (whether partitioned or not) on the secondary market in real-time (or substantially real-time), and the winning bid for a specific space size and time period is able to use the space. In some embodiments, the seller can list the usable space for a specific price or price range, and buyers are able to submit bids on the usable space through the system 100. The seller is able to review and analyze the bids submitted by potential buyers, and can use the system 100 to accept a bid to confirm the transaction. As soon as a bid is accepted, the system 100 can automatically place a hold for payment on the payment means (e.g., credit card, debit card, electronic payment account, or the like) of the buyer.

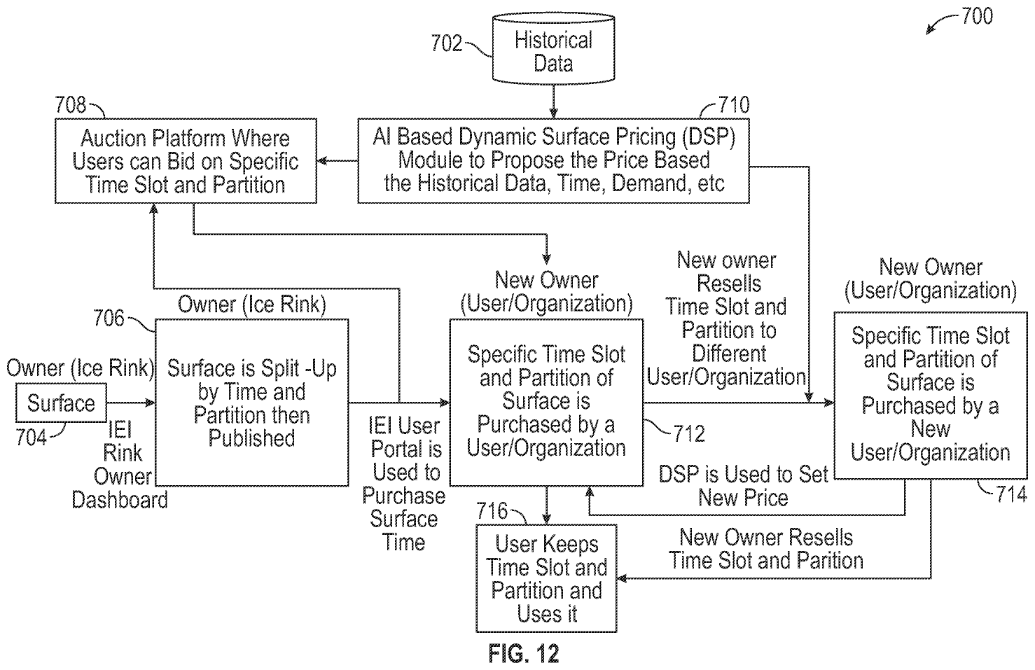

FIG. 12 is another flowchart of a process 700 for implementing the system 100 in a dynamic surface pricing manner. The system 100 can receive as input and electronically store historical data 702. The historical data 702 can include, e.g., space sizes, dates, times, demand, pricing, partitions, combinations thereof, or the like. At step 704, a surface (e.g., space) of an owner is made available for purchase/rent using the system 100. At step 706, the space is purchased/rented by another user and partitioned either in time, size, or both; and subsequently made available for purchase/rent by other users via the system 100. At step 708, the system initiates an auction via a platform viewable on a user interface in which users of the system can bid on the specific time slots and partitions of the space. In some embodiments, at step 710, based on the historical data 702, the system can implement an artificial intelligence or machine learning algorithm/module to generate a recommended price for the space and the user can rely on the recommended price as a starting bid price during the auction.

At steps 712, 714, one or more new owners (user or organization) can purchase/rent one or more specific time slots and/or partitions of the space for use. In some embodiments, the new owner/user/organization can partition the space further, or make the same obtained space available for purchase/rent by others. In some embodiments, the new owner/user/organization can initial another auction and can rely on the DSP module to generate a new recommended price to initiate the auction. The pricing for the usable space can dynamically vary based on the historical data 702 and real-time data of the industry (e.g., low supply of usable spaces can result in higher initial auction pricing). At step 716, the owner from step 706 can decide to keep and use one or more of the partitioned slots of the space, while making the other partitioned slots of the space available for purchase/rent by others.

The user obtaining the usable space from the original owner can therefore use the system to use the space, partition the space and use the portioned spaces, or partition the space to use some of the partitioned space and resell the other partitioned spaces. The system allows the user to resell the space for any desired price and, in some instances, can base the auction price based on historical and/or real-time data. The process can be repeated any number of times and in a variety of space/time fractions to provide flexibility for use of the space. In some embodiments, historical pricing data can be used by the system in an arbitrage transaction to buy a space (whole or partitioned) when the system detects that the current price of the space is below historical market value, and subsequently the system can resell the space when the current price of the space is above historical market value. Such purchase and reselling of the space can be used by individuals and organizations during the bidding function to create a spread between bid and ask.

In some embodiments, the system can provide for different ways of payment for the usable space. In one embodiments, the second user or buyer can pay for the entire amount due. In another embodiment where multiple users are to use the space or where multiple individuals are financially responsible for purchasing the usable space, the system can allow the cost of the usable space “slot” to be split between two or more users. For example, during booking of the usable space slot, the system can allow for a 50%/50% split between two users, or can provide an interface for customization of how the cost should be split between two or more individuals. The user booking the usable space can thereby split the cost in a manner that is not 50%/50% (e.g., 30%/70%, 40%/60%, or the like), or can split the cost between more than two users. A flexible and customizable payment interface is therefore provided by the system.

In some embodiments, the user interface of the exemplary system can have additional options for booking the usable space. For example, the first user or seller can use the interface to create one or more “slots” of available time for the usable space. The user is able to input information such as the usable space location, any team names, team level, schedule available start and end date/time, whether the space should be visible/available to the public or a private listing, and any age restrictions for users of the usable space. Once the listing is published, any user registered to the system can view the listing if the listing meets the search criteria for the second user or buyer.

The second user or buyer can search for available usable space listings using the user interface. The user interface can include a search section for input of search criteria. The list of available usable spaces provides various options for the second user to review. If there is a space of interest to the user, a request can be submitted to the original user/seller by actuating the request link. In some embodiments, rather than a list, the user interface can be in the form of an electronic calendar layout. In such embodiments, all available usable spaces and their available times can be shown in blocks, and a request button can be used to initiate the request for the usable space booking. In the request is initiated, a request window can be generated to receive additional information on the user requesting the usable space booking. All requests for usable spaces are electronically transmitted to the original user/seller, and a notification is sent to the user requesting a response, e.g., approval or rejection of the request to book. In some embodiments, if the space is listed for a specific time period, the buyer can request to purchase only a portion of the time from the seller/owner. For example, if the space is listed for a three hour period of time, the buyer can request to only purchase the space for a block of one hour or two hours. In such instance, the system and/or seller can increase or adjust the price for the space for the shorter period of time.

In some embodiments, the system can adjust the price of the space in real-time based on historical data and/or current market data, as well as the time, size and quantity of the space, to maximize sales of the usable space. For example, the seller can input into the system a block of time(s) of the usable space to sell, and the system can use historical data to sell or maximize the sale price of the usable space, or decide that dividing the usable space by time, size and/or quantity would be optimal for maximizing profit for the seller based on the historical data. In some embodiments, as the time of availability of the usable space approaches expiration, the system can re-price the specific slots of time/partitions to maximize the chance of selling the usable space before expiration of the time. The usable space can therefore be priced in view of time on the market and demand/interest in the usable space for the specific time/size.

The original user/seller can access another user interface in which a list of request for booking of the usable space is provided. If the original user/seller accepts and confirms the booking, the usable space booking can be reflected in the database and in the electronic schedule interface. In some embodiments, the payment transaction can involve a direct payment from one user to the other. In some embodiments, the payment transaction can involve a split in payment between two or more users. In some embodiments, the payment transaction can involve an exchange of a reciprocal usable space. For example, if the second user/buyer owns a usable space or has previously purchased another slot for a usable space, the second user/buyer can offer the option to exchange the other usable space slot as payment for the usable space being booked. If the price is different between the two usable spaces, the system can credit the user accordingly through future credits or monetary value, or can request additional payment to confirm the booking.

In some embodiments, the booking can be shown with a “pending” status and the first user/seller can still receive bids to request the specific usable space slot with a hold on requester credit cards until one booking transaction is complete. For example, once the credit card or reciprocal space is exchanged the request is confirmed by the seller of the usable space. As a further example, if the request is denied, the usable space slot remains available for booking. The status of the usable space can therefore be available, pending, or booked, and can be shown in the second user/buyer interface as “my slots” or “my bookings” once the request and booking is confirmed.

In some embodiments, the system can provide for a direct sale transaction, e.g., the facility owner/user selling the usable space slot to an organization or another user. In some embodiments, the system can provide for a resale transaction, e.g., the facility owner/user selling the usable space slot to an organization or another user, and the organization/other user reselling the usable space slot (or a portion of the slot) to another buyer.

In some embodiments, the system can allow for a program event sale transaction. For example, an external organization can work with the facility/usable space to obtain customers to book the usable space slot(s), with the external organization receiving a commission for finding and booking customers. For example, the usable space can be open to a larger number of individuals (e.g., 200), and the external organization can assist with finding and booking the individuals for use of the space. An increased volume of booking for the usable space can thereby be achieved. In some embodiments, there may be no restriction on the booking limit, with the usable space owner being informed when a large number of individuals books the space and provides additional space for further booking. This can increase overall sales and revenue for the owner of the usable space.

In some embodiments, the system can allow organizations to book the usable space for specific programs. The seller can rely on a lower percentage of cost to beat competitor's processing charges for their current registrations, and receive a booking based on the lower cost. The organization booking the slot can use the space for team practice, for example, or to promote their programs.

In some or all embodiments, the system can ensure that insurance is obtained or provided for use of the usable space to limit liability of the space owner. As discussed above, the system can provide for transactions in which the cost is split between two or more users, or a credit (or partial credit) of reciprocal usable space usage is provided. In some embodiments, the system can be used to book spaces for tryouts, with a partnership formed to split costs of marketing the tryouts (or other events) in multiple locations, collecting money for the organization/team in the respective bank accounts of the organizations. In some embodiments, the system can provide a line of credit to an organization or individual.

In some embodiments, the system can automatically reserve a slot when a request is submitted. In some embodiments, the system can provide for a “request to reserve” format when the user requests to reserve a slot and the system holds the payment until the seller has confirmed the reservation. In such embodiments, the usable space owner has the leverage to decide whether the sale is instantaneous on booking or if it has to pass through an approval process, where the sale request is queued and realized only on approval by the space owner within a predetermined time period, e.g., 24 hours, or the like. If no approval/rejection is taken by the space owner during the predetermined time period, the request for purchase can be automatically approved by the system and fully booked.

In some embodiments, the request to reserve can be in the form of a bid on a range of prices posted by the seller, with the bid request sent to the seller for confirmation. In some embodiments, the user can request to book/buy a full usable space for the specific timeframe and then sell the full usable space in partitioned sections (e.g., halves, thirds, quarters) to create more transactions on a single usable space. In some embodiments, the purchase transaction can occur with the buyer and seller knowing all details about each other, while in other embodiments the buyer details may not be available to the seller. In some embodiments, the system can be used for fundraising purposes. In some embodiments, the price for the usable space can be dynamic based on historical data and time, with the price fluctuating in real time before a sale is “locked in”. In some embodiments, the buyer can have the option to cancel their booking before 48 hours of the actual start time of the usable space usage. In doing so, 50% of the funds can be refunded to the buy account from the seller account. The original seller can resell the space to another buyer at a higher cost or the original cost, ensuring additional revenue. In some embodiments, the system can provide for additional payment plans, instant payouts, intra-platform transfers, or the like.

In some embodiments, multiple usable spaces can be selected for purchase or rent in one transaction, and the processing device can receive input for customized payment for the transaction, e.g., splitting of funds for each usable space, splitting of funds between two or more users, or the like. In some embodiments, the usable space size can be adjustable internally based on the activity to be performed, e.g., the partitioned size can be adjusted to gain or decrease the internal space and/or partitions based on the type of use of the space. As an example, the usable space can be one or more batting cages that are used for batting baseballs in the winter. However, such spaces can be transformed into shooting bays for hockey, and the overall size of the space can be different from the batting cage size, e.g., four baseball batting cages can be transformed into eight hockey shooting stations in the same amount of physical space. The same physical size of the usable space can therefore be transformed depending on the activity to be performed, and the system can automatically adjust the available partitions or spaces depending on the activity to be performed and the size needed for each type of activity. The usable space can therefore be customized by the user depending on the type of activity to be performed at the usable space, and further scheduling of the events at the partitioned spaces can be adjusted by the system to allow for greater customization.

The user interfaces of the exemplary system can include additional options for booking the usable space. For example, the user interface can include a schedule in which a game slot can be created, with the user capable of inputting information such as the space location, a team name, team level, scheduling start and end dates, scheduling start and end times, age barriers, birthday, and publishing. The user interface can include a schedule in which open use of the space can be created, with the user capable of inputting information such as the space location, space name, whether the use is recurring, daily/weekly/custom, the days for the recurring schedule, the start and end dates and/or times, the price, and publishing details. A request to reserve the space can be permitted by the user selling/renting the space. A search filter for available space can provide the calendar results to indicate which spaces are available based on the criteria input by the user. Once a request to reserve has been submitted through the system, the seller or original user can visualize the different requests and associated information in a color-coded manner. For example, green color can be used to show approved requests, yellow color can be used to identify requests where additional information was requested from the buyer, and red color can be used to identify requests that have been denied.

In some embodiments, an organization or individual can set up indirect usable spaces as being available for purchase/rent without first having to buy the usable space on the system 100. As such, the system 100 provides means for differentiating between usable spaces purchased on the system 100 and other spaces being added to the system 100 but purchased elsewhere. In some embodiments, exceptions on the commissions can be created using the user interface.

In some embodiments, the system can be used for a variety of exchanges and transactions involving the usable space. For example, in some embodiments, an owner of a usable space can sell the entire available space to the system (with the system operator taking on the risk of finding a buyer), and the system interface can be used to locate a buyer of the usable space (whether partitioned or not). The system can create a schedule indicating when the usable space is available, and a buyer can use the system to purchase the desired usable space. The system collects payment from the buyer, with the price of the usable space determined using, e.g., dynamic surface pricing, an auction, a bid/ask spread to multiple buyers, or the like. The system can make a payment to the original owner an agreed upon price, minus any commissions, transaction chargers, or the like, from the sale of the usable space. Different market prices and supply/demand of the usable spaces can be used to adjust the selling price of the usable space on the system. In some embodiments, buyers of a usable space can post a request (or query) for a specific time and/or usable space size, and the system can, e.g., output an available usable space that meets the request parameters, inform sellers of the request to encourage sellers to make available their usable space to meet the parameters, notify the buyer when the requested time and/or usable space size becomes available, or the like.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A system for usable space selection, the system comprising:
a database electronically storing data associated with one or more usable spaces available for purchase or rent from a first user, the data including (i) a geographic location of the one or more usable spaces, and (ii) a time period of availability of the one or more usable spaces; and
a processing device in communication the database, the processing device configured to:
receive as input a query from a second user regarding a desired geographic location of the one or more usable spaces available for purchase or rent;
receive a selection from the second user of a desired usable space of the one or more usable spaces, the selection including (i) a specific time period for use of the desired usable space, and (ii) a size associated with the desired usable space;
receive a partitioning input from the second user to partition at least one of (i) the specified time period of the selected desired usable space into partitioned time periods, or (ii) the size of the selected desired usable space into partitioned sizes; and
receive a command to add the selected desired usable space to the database as available for purchase or rent from the second user for at least one of the partitioned time periods or the partitioned sizes.

2. The system of claim 1, wherein the one or more usable spaces include an ice rink, a soccer field, a football field, a tennis court, or a basketball court.

3. The system of claim 1, wherein the size associated with the desired usable space is a full space, and the partitioned sizes includes halves, thirds, or quarters of the full space.

4. The system of claim 1, wherein the specific time period selected for use of the desired usable space is 60 minutes, and the partitioned time periods include 30 minute increments or 15 minute increments.

5. The system of claim 1, wherein each of the partitioned sizes of the selected desired usable space is available for purchase or rent from the second user for the selected specific time period.

6. The system of claim 1, wherein each of the partitioned time periods is smaller in time than the specific time period for use of the desired usable space selected by the second user.

7. The system of claim 1, wherein each of the partitioned sizes is smaller in size than the size associated with the desired usable space selected by the second user.

8. The system of claim 1, wherein the processing device is configured to automatically schedule a space preparation event for the selected desired usable space immediately prior to the specific time period for use of the desired usable space.

9. The system of claim 8, wherein the space preparation event includes at least one modification of the desired usable space in preparation for an activity to be conducted at the desired usable space for the specific time period.

10. The system of claim 9, wherein the at least one modification includes positioning of goals on an ice rink or a field, positioning of cones on the ice rink or the field, or resurfacing ice of the ice rink.

11. The system of claim 1, wherein the processing device is configured to automatically schedule a space preparation event for each of the partitioned time periods and each of the partitioned sizes available for purchase or rent from the second user.

12. The system of claim 11, wherein the space preparation events are automatically scheduled between each of the partitioned time periods.

13. The system of claim 11, wherein the processing device is configured to automatically adjust a length of each of the partitioned time periods to accommodate the scheduled space preparation event.

14. A method for usable space selection, comprising:
electronically storing in a database data associated with one or more usable spaces available or purchase or rent from a first user, the data including (i) a geographic location of the one or more usable spaces, and (ii) a time period of availability of the one or more usable spaces;
receiving as input, via a processing device, a query from a second user regarding a desired geographic location of the one or more usable spaces available for purchase or rent;
receiving a selection, via the processing device, from the second user of a desired usable space of the one or more usable spaces, the selection including (i) a specific time period for use of the desired usable space, and (ii) a size associated with the desired usable space;
receiving a partitioning input, via the processing device, from the second user to partition at least one of (i) the specific time period of the selected desired usable space into partitioned time periods, or (ii) the size of the selected desired usable space into partitioned sizes; and
receiving a command, via the processing device, to add the selected desired usable space to the database as available for purchase or rent from the second user for at least one of the partitioned time period or the partitioned sizes.

15. The method of claim 14, wherein each of the partitioned time periods is smaller in time than the specific time period for use of the desired usable space selected by the second user.

16. The method of claim 14, wherein each of the partitioned sizes is smaller in size than the size associated with the desired usable space selected by the second user.

17. The method of claim 14, comprising automatically scheduling a space preparation event for the selected desired usable space immediately prior to the specific time period for use of the desired usable space.

18. The method of claim 17, wherein the space preparation event includes at least one modification of the desired usable space in preparation for an activity to be conducted at the desired usable space for the specific time period.

19. The method of claim 14, comprising automatically scheduling a space preparation event for each of the partitioned time periods and each of the partitioned sizes available for purchase or rent from the second user.

20. A non-transitory computer-readable medium storing instructions for usable space selection that are executable by a processing device, wherein execution of the instructions by the processing device causes the processing device to:
electronically store in a database data associated with one or more usable spaces available or purchase or rent from a first user, the data including (i) a geographic location of the one or more usable spaces, and (ii) a time period of availability of the one or more usable spaces;
receive as input, via a processing device, a query from a second user regarding a desired geographic location of the one or more usable spaces available for purchase or rent;
receive a selection, via the processing device, from the second user of a desired usable space of the one or more usable spaces, the selection including (i) a specific time period for use of the desired usable space, and (ii) a size associated with the desired usable space;
receive a partitioning input, via the processing device, from the second user to partition at least one of (i) the specific time period of the selected desired usable space into partitioned time periods, or (ii) the size of the selected desired usable space into partitioned sizes; and
receive a command, via the processing device, to add the selected desired usable space to the database as available for purchase or rent from the second user for at least one of the partitioned time period or the partitioned sizes.
